(19) United States
(12) Patent Application Publication
(10) Pub. No.: US 2024/0372660 A1
(43) Pub. Date: Nov. 7, 2024

(54) TRANSMISSION OF RESOURCE UNITS IN A WIRELESS NETWORK USING UNEQUAL MODULATION IN DIFFERENT SPATIAL STREAMS OR VARYING NUMBER OF SPATIAL STREAMS

(71) Applicant: NXP USA, Inc., Austin, TX (US)

(72) Inventors: Yan Zhang, Palo Alto, CA (US); Rui Cao, Sunnyvale, CA (US); Amer Al-Baidhani, Santa Clara, CA (US); Hongyuan Zhang, Fremont, CA (US)

(21) Appl. No.: 18/653,060

(22) Filed: May 2, 2024

Related U.S. Application Data
(60) Provisional application No. 63/499,721, filed on May 3, 2023.
(60) Provisional application No. 63/568,040, filed on Mar. 21, 2024.

(51) Int. Cl. H04L 5/00; H04B 7/0452; H04L 1/00

(52) U.S. Cl. CPC H04L 5/0044; H04B 7/0452; H04L 1/0003

(57) ABSTRACT

A method and system for wireless transmission comprises receiving bits of resource units (RU) at a physical layer processing unit of a wireless device. The bits of the RUs are parsed into a plurality of RU fragments carried by one or more spatial streams. One of the resource unit fragments is modulated with a first modulation and another of the resource unit fragments is modulated with a second modulation which is different from the first modulation. Each spatial stream carrying the resource units fragments which are modulated is then mapped to one or more antenna for wireless transmission.

### CROSS-REFERENCE TO RELATED APPLICATIONS

This application is entitled to the benefit of U.S. Provisional Patent Application Ser. No. 63/499,721, filed May 3, 2023 and U.S. Provisional Patent Application Ser. No. 63/568,040, filed Mar. 21, 2024, the contents of which are each incorporated herein by reference in its entirety.

### BACKGROUND

Signals from overlapping basic service set (OBSS) or other wireless technologies such as Bluetooth and ZigBee could interfere with signals transmitted over a channel operated in accordance with IEEE 802.11 otherwise known as WiFi. Before transmitting on the channel, a transmitter performs a clear channel assessment (CCA) to determine if the channel is busy or idle. Parameters of the CCA to determine if the channel is busy or idle vary depending on whether the channel is a primary or secondary 20 MHz channel. For example, a clear channel detection threshold parameter for a primary channel is 20 dBm lower than for a secondary channel resulting in resource units transmitted on the non-primary 20 MHz channels typically experiencing higher interference than resource units (RUs) transmitted on the primary 20 MHz channel in a fading channel environment. In IEEE 802.11, a client station is assigned a single modulation and coding scheme (MCS) to transmit RUs over the channels which are determined to be idle. The RU could span multiple 20 MHz channels or a multiple of a smallest 26 tone RU unit if the assigned RU is less than 20 MHz. Because the MCS assignment is not correlated to channel quality observed at each 20 MHz channel, the RUs received at a wireless station could have a varying signal-to-noise ratio.

### BRIEF DESCRIPTION OF DRAWINGS

FIG. 1 illustrates an example wireless communications system in accordance with an embodiment.

FIG. 2 is an example transmit block diagram for transmitting resource units (RU) fragments having unequal modulation in different spatial streams in accordance with an embodiment.

FIG. 3 is an example of a transmit block diagram for transmitting RU fragments having unequal modulation and which are each parsed to a varying number of spatial streams in accordance with an embodiment.

FIG. 4 illustrates example signaling in user information of a physical layer protocol data unit (PPDU) to transmit RU fragments in accordance with an embodiment.

FIG. 5 illustrates example signaling in user information of a basic trigger frame to transmit RU fragments in accordance with an embodiment

FIG. 6 is an example of signaling unequal modulation for partially overlapping bandwidth RU of different users for a multi-user-multiple input multiple output (MU-MIMO) transmission in accordance with an embodiment.

FIG. 7 is a flow chart of functions for transmitting RU fragments in accordance with an embodiment.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, “an example”, or similar language means that a particular feature, structure, or characteristic described in connection with the indicated embodiment is included in at least one embodiment of the present invention. Thus, the phrases “in one embodiment”, “in an embodiment”, “an example”, and similar language throughout this specification may, but do not necessarily, all refer to the same embodiment.

Embodiments disclosed herein are directed to transmitting resource unit (RU) fragments having unequal modulation in a varying number of spatial streams or transmitting RU fragments having unequal modulation in different spatial streams. Further, the modulation is selected based on a channel quality or interference statistic reported by a client station for downlink transmission from an access point or measured by the access point for uplink transmission by the client station. A signaling scheme further indicates transmitting RU fragments having unequal modulation in different spatial stream or transmitting RU fragments having unequal modulation in a varying number of spatial streams. Well known instructions, protocols, structures, and techniques have not been shown in detail in order not to obfuscate the description.

Several aspects of the disclosed WiFi system will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

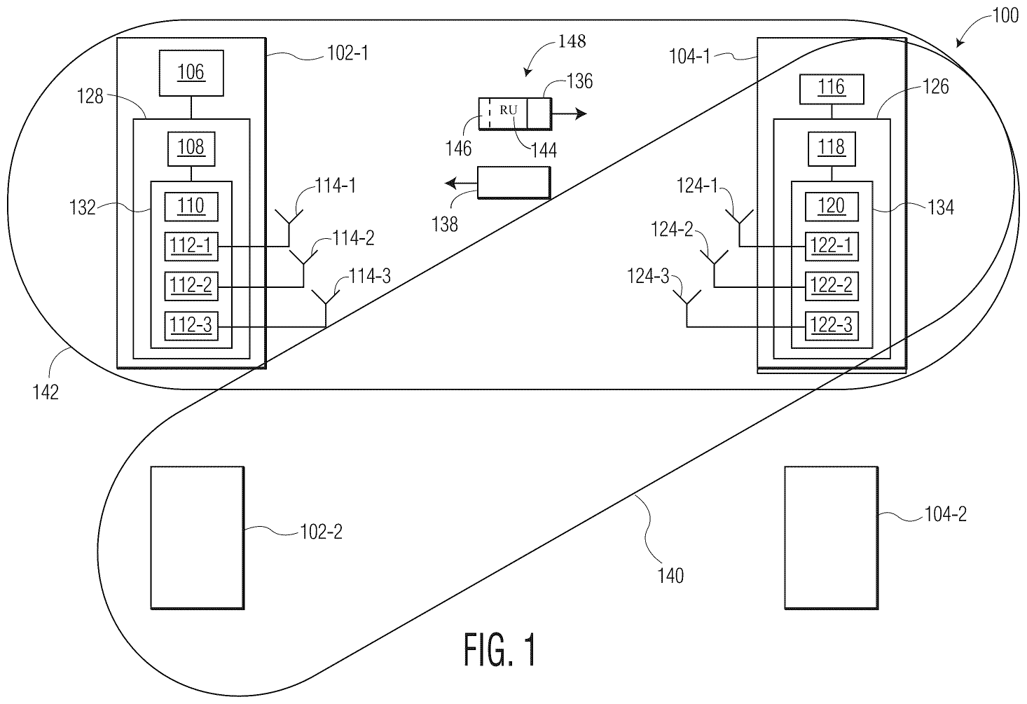

FIG. 1 illustrates an example wireless communications system 100 in accordance with an embodiment. In the embodiment shown in FIG. 1, the communications system 100 includes one or more access point (AP) 102 and one or more client stations (STA) 104, referred to generally as wireless devices. The communications system 100 can be used in various applications, such as industrial applications, medical applications, computer applications, and/or consumer or enterprise applications. In some embodiments, communications system 100 may be a wireless communications system compatible with an IEEE 802.11 protocol such as IEEE 802.11bn protocol and various other iterations of the 802.11 specification referred to herein including but not limited to IEEE 802.1lac, IEEE 802.11be, and IEEE 802.1lax. IEEE 802.1lac is referred to as very high throughput (VHT). IEEE 802.1lax is referred to as high efficiency (HE). IEEE 802.11be is referred to as extreme high throughput (EHT). IEEE 802.11bn is referred to as ultra-high reliability (UHR). The client station 104 may be an end device which wirelessly communicates with an AP 102 while the AP 102 may allow connections by nearby associated devices such as client stations to a wired network such as the Internet (not shown).

The communication system 100 includes one or more AP 102. Two AP 102 are shown as 102-1 and 102-2 in FIG. 1, but the communication system 100 may include other suitable numbers (e.g., 1, 2, 3, 5, 6, etc.) of APs in various scenarios and embodiments. A wireless device in the form of an AP 102-1 includes a host processor 106 coupled to a network interface 128. The network interface 128 includes a medium access control (MAC) processing unit 108 and a physical layer (PHY) processing unit 132. The PHY processing unit 132 includes a plurality of transceivers 112 (e.g., transmitters and/or receivers) coupled to a plurality of antennas 114. Although three transceivers 112 (112-1, 112-2, 112-3) and three antennas 114 (114-1, 114-2, 114-3) are illustrated in FIG. 1, the AP 102-1 includes other suitable numbers (e.g., 1, 2, 4, 5, etc.) of transceivers 112 and antennas 114 in other embodiments. In an embodiment, the MAC processing unit 108 and the PHY processing unit 128 are configured to operate according to a communication protocol such as Institute of Electrical and Electronics Engineers (IEEE) 802.11 WiFi standard.

The communication system 100 also includes one or more wireless devices in the form of a plurality of client stations (STA) 104. Two client stations 104 are shown as 104-1 and 104-2 in FIG. 1, but the communication system 100 may include other suitable numbers (e.g., 1, 3, 4, 5, 6, etc.) of client stations in various scenarios and embodiments. At least one of the client stations 104 (e.g., client station 104-1) is configured to communicate with the AP 102. The client station 104-1 includes a host processor 116 coupled to a network interface 126 which includes a MAC processing unit 118 and a PHY processing unit 134. The PHY processing unit 134 includes a plurality of transceivers 122 which include a respective transmitter and receiver and the transceivers 122 are coupled to a plurality of antennas 124. Although three transceivers 122 and three antennas 124 are illustrated in FIG. 1, the client station 104-1 includes other suitable numbers (e.g., 1, 2, 4, 5, etc.) of transceivers 122 and antennas 124 in other embodiments.

In various embodiments, the PHY processing unit 132 of the AP 102-1 is configured to generate and transmit frame 136 via the antenna(s) 114 over an air interface 148 in a downlink direction and the PHY processing unit 134 of the client station 104-1 is configured to receive frame 136 via the antenna(s) 124 over an air interface 148. Similarly, the PHY processing unit 134 of the client device 104-1 is configured to generate and transmit frame 138 via the antenna(s) 124 in an uplink direction and the PHY processing unit 132 of the AP 102-1 is configured to receive the frame 138 via the antenna(s) 114. In an example, the frames 136, 138 may be a physical-layer protocol data units (PPDU) or basic trigger frame for communicating data between the AP 102-1 and the client device 104-1 and the frames (and fields therein) may be transmitted as a waveform in the downlink direction or uplink direction.

A basic service set (BSS) defines a network topology which includes an AP and one or more client station associated with the AP. The AP and client station may be associated through an association process defined by IEEE 802.11. In an example, AP 102-1 and client station 104-1 may be associated and define a basic service set (BSS) 142 and AP 102-2 and client station 104-1 may be associated and define another BSS 140. BSS information of the BSS may include capabilities and operating parameters of the BSS set up by an AP such as one or more of an BSS operating bandwidth, BSS operating channel, and a BSS identification (BSSID) such as a media access communication (MAC) address of the access point in the BSS. The BSS operating channel may define 20 MHz channels used by the AP or client station in the BSS and the BSS operating bandwidth may define a bandwidth used by the AP or client station in the BSS. In an example, the AP 102 or AP 104 may transmit a management frame such as a beacon frame or action frame to the associated client station to announce presence of the BSS and the BSS information. Further in some examples, one BSS may overlap with another BSS in which case the BSS may be referred to as an overlapping (OBSS).

The transmitter and receiver of each of the AP and client station may transmit or receive data in a resource unit (RU). The frame 136, 138 may include one or more RUs, an example of which is shown as RU 144 in frame 136. The RU is a group of subcarrier tones in a bandwidth for downlink communication from the AP to client station or uplink communication from the client station to the AP. The RU may span a bandwidth of a multiple of 20 MHz channels or be a multiple of a smallest 26-tone RU if the RU is less than 20 MHz. In an example, the RU size may be a multiple of a smallest 26-tones RU (e.g., 26-tone, 52-tone or 106-tone) if the assigned RU size is less than or equal to 242-tones, otherwise the RU is a multiple of 242-tones RU (equivalent to 20 MHz bandwidth). The RU may be transmitted based on a modulation and coding scheme (MCS) defined by IEEE 802.11 which defines one or more of a modulation type such as binary phase shift keying (BPSK), quadrature phase shift keying (QPSK), or quadrature amplitude modulation (QAM) and coding scheme (e.g., rate of bits transferred and error coding). Further, the RU may be transmitted over one or more independent number of spatial streams (Nss) mapped to the plurality of antenna of the transmitter and receiver. The MCS and number of spatial streams may define a rate of transmission of the RU from one wireless device to another wireless device.

In an example, an OBSS may produce interference with a BSS. In other examples, other wireless technologies such as Bluetooth and ZigBee may produce interference. An AP or client station may perform a clear channel assessment (CCA) before transmitting an RU to determine whether a channel is busy or idle. The CCA may involve determining whether a channel quality indicator (CQI) meets a threshold. In an example, the detection threshold for a primary 20 MHz channel may be 20 dBm lower than the detection threshold for secondary 20 MHz channels and, as a result, RUs transmitted over the non-primary 20 MHz channels may experience higher interference than RUs transmitted over the primary 20 MHz channel when a CCA is idle and some RUs may have better channel quality than other RUs especially in a fading channel environment. Typically, one rate defined by the MCS and Nss is assigned to one wireless device across assigned RUs of the wireless device. This single rate assignment for the wireless device may not match the actual channel quality. Each RU may be defined by a plurality of RU fragments, where each RU fragment is defined by a subset of the plurality of subcarrier tones of the RU. An example of the RU fragment is shown as RU fragment 146 in RU 144. The assigned rate is most likely under a capacity of an RU fragment bandwidth having better CQI values and above the capacity of an RU fragment bandwidth having worse CQI values. Ideally, using different data rates for RU fragments can maximize the transmission data rates, but significant changes to the transmitter and receiver would be needed to handle the different rates for different RU fragments. Media access control (MAC) layer changes would include having a separate physical layer protocol data unit (PSDU) for each RU fragment with different MCS values and a block acknowledgement (BA) for each PSDU. Physical (PHY) changes include adding parallel PHY transmit/receive processes for each RU fragment with the different MCS.

Embodiments disclosed herein are directed to transmitting different RU fragments having unequal modulation in a varying number of spatial streams or transmitting different RU fragments having unequal modulation in different spatial streams by a wireless device to improve throughput without changing a data rate for the RU fragments. In an example, the physical layer 132, 134 of a transmitter may have an unequal modulation and spatial stream unit 110, 120 to cause the transmitter to transmit RU fragments having unequal modulation in a varying number of spatial streams or transmit RU fragments with unequal modulation in different spatial streams. In an example, the RU fragment may be a multiple of 26 tones if the RU is less than 242 tones or 20 MHz bandwidth or a multiple of 242 tones if the RU spans one or more 20 MHz channels. The receiver may also support receiving the RU fragments. Transmitting RU fragments having unequal modulations in different spatial streams and transmitting RU fragments having unequal modulations in a varying number of spatial streams to improve SNR without changing a data rate per RU fragment requires less changes to a MAC and PHY receive process and can be easily adopted in next generation IEEE 802.11. System performance such as throughput and latency is improved and a signal-to-noise ratio of RU fragments received by a wireless device is similar across channels.

In an example, multi-user MIMO (MU-MIMO) transmission by a wireless device to multiple users with different supported bandwidth, when a bandwidth of an RU to one user (i.e., first remote wireless device) partially overlaps with a bandwidth of an RU to another user (i.e., second remote wireless device) during simultaneous transmission of the RUs to the two users may result in increased signal to interference and noise ratios (SINR) for the RUs. The SINR for an RU may be increased for an overlapped RU fragment of the RU compared to an non-overlapped RU fragment of the RU. To improve the SINR, unequal modulation is applied to different RU fragments of an RU having the larger bandwidth compared to using a same signal modulation for the RU fragments of the RU having the larger bandwidth.

During an association, AP 102 and client station 104 may transmit and receive support associated with transmitting RU fragments. For example, a receiver which supports receiving RU fragments having unequal modulations in a varying number of spatial streams may assist a transmitter to select between unequal modulation in a varying number of spatial streams or equal modulation for transmission. For example, the receiver may report for different RU fragments preference for unequal modulation in a varying number of spatial streams based on measured CQI values of RU fragment bandwidths or report preferred operation based on a measured signal to noise (SNR) values and sensitivity evaluations. The CQI values may be measured in an uplink direction from a client station to an AP or downlink direction from an AP to a client station. If the receiver does not indicate the preference, CQI values reported from the receiver to the transmitter may be used by the transmitter as an indication to choose unequal modulation in a varying number of spatial streams for different RU fragments for transmission if a difference between two CQI in different spatial streams or RU fragment bandwidths are greater than a certain threshold. In another example, the receiver further supporting receiving different RU fragments having unequal modulations in different spatial streams may also assist an AP to select between unequal modulations for RU fragments transmitted in different spatial streams or equal modulation. The receiver may report preference for unequal modulation of RU fragments transmitted in different spatial streams based on the measured CQI values for RU fragment bandwidths per stream or report preferred operation based on measured SNR values and its own Rx sensitivity evaluations. If the receiver does not feedback the preference to the transmitter, CQI values reported from the receiver can be used as an indication for the transmitter to choose unequal modulation of RU fragments transmitted in different spatial streams if a difference between two CQI in different spatial streams or RU fragment bandwidths are greater than a certain threshold.

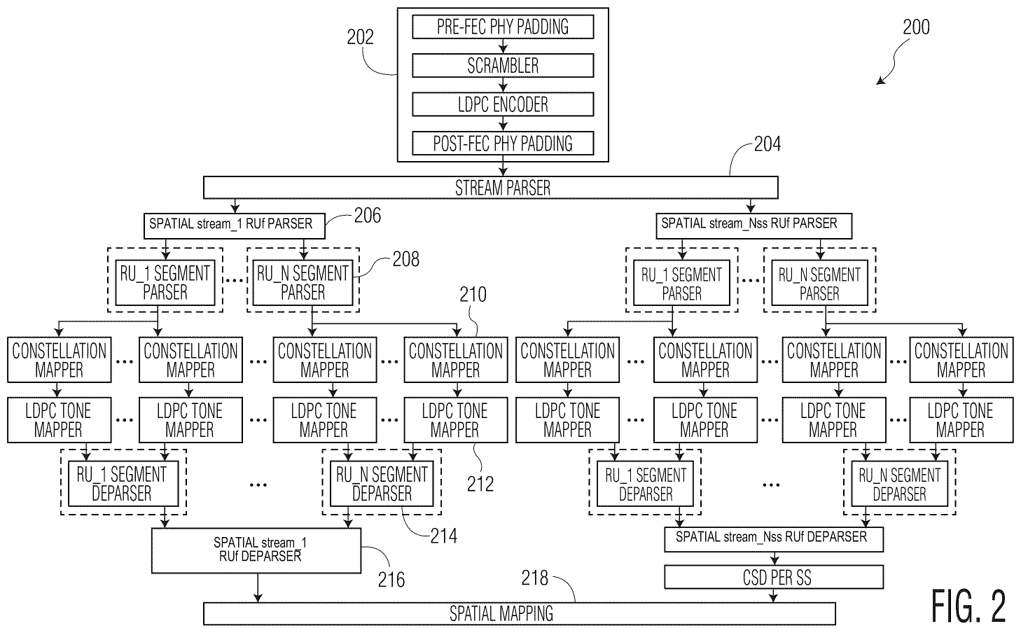

FIG. 2 is an example transmit block diagram 200 for transmitting resource units (RU) fragments having unequal modulation in different spatial streams in accordance with an embodiment. A number of streams Nss may be used to transmit the RU fragments and in an example the RU fragments may be transmitted by the wireless receiver using a same number of spatial streams. Among other conventional components, the transmit block diagram 200 has a stream parser 204 which receives bits of RUs from a padding, scrambling, and encoding circuitry referred to collectively as circuitry 202. Bits of an RU may be jointly encoded by a low density parity check (LDPC) coder in an example. The bits may be assigned by the stream parser 204 to the different streams in a round-robin fashion in an example. A spatial stream RU fragment (RUf) parser 206 may parse a spatial stream of RUs into a plurality of RU fragments (referred to as RU_i, where i is an integer which indicates a particular RU fragment) of RUs and an RU segment parser, an example of which is RU segment parser 208, may further parse the RU fragments if the RU fragment is larger than a certain bandwidth such as 80 MHz. In an example, the RU segment may have a minimum bandwidth of 20 MHz or 80 MHz depending on interference detection by the transmitter in one or more channels, and a maximum number of RU segments for an RU fragment may be four. Each RU may be transmitted to a particular user or wireless station. A constellation mapper and tone mapper, an example of which is constellation mapper 210 and low density parity code (LDPC) tone mapper 212, may be executed for a respective output of the segment parser to produce different modulation for RU fragments. After constellation mapping and tone mapping, the RU segment deparser, an example of which is RU segment deparser 214, may perform RU_i segment deparsing to generate the RU fragment. Spatial stream RUf fragment deparser 216 may receive the RU fragments and form a spatial stream i to carry the RU fragment which is then provided to the spatial mapper 218 to be spatially mapped to one or more antenna for transmission. The different constellation mappers and LDPC tone mappers in the transmit block diagram 200 may perform unequal modulation of RU fragments but a number of streams for the different RU fragments may be the same. The RU fragments may be transmitted in different streams. In an example, each RU fragment may be transmitted in one stream as shown or could be transmitted in a same number of streams in other examples.

RU segment parsers are optionally included in the transmit block diagram 200 for spatial streams 1≤s≤N, as indicated by a dotted box. If the size of an RU fragment is greater than 996 tones or 160 MHz, then segment parser/deparser is added for RU_i to further parse an RU fragment. Otherwise, RU_i (1≤i≤N) segment parsers may not be included after the spatial stream RU parser. An LDPC tone mapper size may also need to be modified based on whether the RU fragment is segmented or not. The RUs transmitted in accordance with the transmitter block diagram may be transmitted to a single user (e.g., client station or AP) and over a plurality of antenna, defining a single user multi-input multi-output (SU-MIMO) transmission. Further, in some examples, segments of RU fragments of an RU may be unequally modulated while other RU fragments may have a same modulation.

In an example, unequal modulation may be allocated for multi-user MIMO (MU-MIMO) transmission when a bandwidth of an RU to one user (i.e., wireless device) partially overlaps with a bandwidth of an RU to another user (i.e., another wireless device) during a simultaneous transmission. In an example, client station_1 may have a 80 MHz device bandwidth and client station_2 may have a 160 MHz device bandwidth. In an example, a client station_1 may be allocated an RU only on primary 80 MHz of a spatial stream and a client station_2 may be allocated an RU on both a primary 80 MHz channel and secondary 80 MHz channel of a spatial stream. The RUs in the two spatial streams may overlap in the primary 80 MHz channel. Such mixed bandwidth (BW) MU-MIMO can be generalized to mixed-RU MU-MIMO in an even wider bandwidth orthogonal frequency division multiple access (OFDMA) transmission. For example, an 320 MHz OFDMA may have one client station allocated to 996 RU (80 MHz) and another client station allocated to a partially overlapped 996*2 (160 MHz) RU. The received signal to interference and noise ratio (SINR) on a primary 80 MHz channel likely be worse than a secondary 80 MHz channel without the unequal modulation. As a result, the unequal modulation applied to different RU fragments of an RU having the larger bandwidth improves performance compared to using a same modulation assigned to an client station for the entire RU.

A number of coded bits per OFDM symbol over assigned RU for user u, N_{CPBS,u} may be calculated as a summation of a number of coded bits per OFDM symbol over all the RU fragments with different modulation. The calculation is shown as N_{CBPS,u}=Σᵢ₌₀^{N}^{_{SRU,u}}⁻¹ where N_{CBPS,i,u}, where N_{SRU,u} is the number of RU fragments within the assigned RU, N_{CBPS,i,u}=N_{SD,u,i}·N_{ss,u}·log₂ M_{u,i} is number of coded bits of the ith RU fragments per OFDM symbol. N_{SD,u,i} and M_{u,i} are the Number of Data Tones and Modulation Order of the ith RU fragments, N_{ss,u} is the number of spatial streams for user u. Further, a number of coded bits per OFDM symbol segment can be calculated as N_{CBPS,short,u}=Σᵢ₌₀^{N}^{_{SRU,u}}⁻¹ N_{SD,short,i,u}·N_{ss,u}·log₂ M_{u,i}, and N_{SD,short,i,u} is the number of data tones of the ith RU fragment within one OFDM symbol segment for user u. The RU parser divides N_{CBPSS,u}=Σᵢ₌₀^{N}^{_{SRU,u}}⁻¹ N_{CBSS,i,u} coded bits into N_{SRU,u} blocks each with N_{CBPSS,i,u}=N_{SD,u,i}·log₂ M_{u,i} bits for the ith RU fragments. The segment parser used in the ith RU fragment with size greater than 996-tone further divides N_{CBPSS,i,u} coded bits into L blocks of N_{CBPSS,l,i,u} bits respectively, where l is the index of each 80 MHz frequency subblock index, and l=0,1 since the largest size of the RU fragment is 2×996-tone.

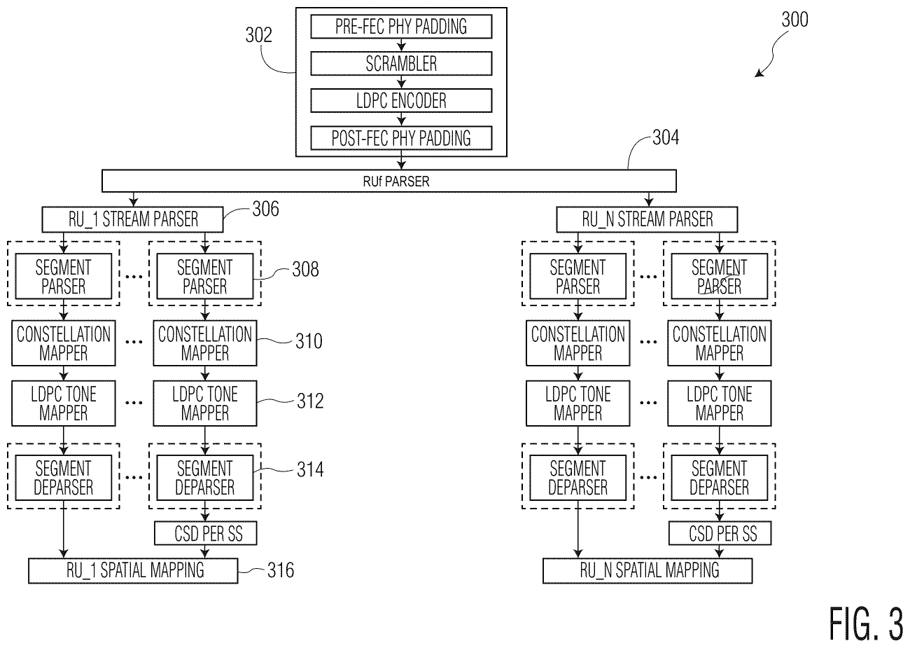

FIG. 3 is an example of a transmit block diagram 300 for transmitting RU fragments having unequal modulation and which are each parsed to a varying number of spatial streams in accordance with an embodiment. In an example, the transmit block diagram 300 has an RU fragment (RUf) parser 304 which receives bits from a padding, scrambling, and encoding circuitry referred to as circuitry 302 and parses the bits into RU fragments of an RU. The RU may be transmitted to a user such as a wireless device. The RU fragments are provided to an RU stream parser 306 which parses the RU fragments to a plurality of streams. Different RU fragments may be parsed into varying number of streams. For example, RU fragment RU_1 may be parsed into l streams to carry the RU fragment while RU fragment RU_2 may be parsed into m streams to carry the RU fragment, where l and m are integers. The segment parser, an example of which is segment parser 308, may optionally further parse the RU fragment and the constellation mapper and tone mapper, an example of which is constellation mapper 310 and LDPC tone mapper 312, may perform a respective modulation and tone mapping within an RU fragment to produce different modulation for different RU fragments. A segment deparser, an example of which is segment deparser 314, may then deparse the parsing by the segment parser and the streams of each RU fragment after the deparsing are then mapped to an antenna by a spatial mapper 316. An output of RU_i Spatial Mapping 316 may connect to one or more of Antenna 1 . . . Antenna N. In an example, spatial mapping 316 may facilitate performing an RU fragment deparsing and RU transmission over the antennas. Antenna mapping for spatial streams 1≤s≤ MaxNₛₛ may be added after spatial mappings 316 for RU_i (1≤i≤N), where MaxNₛₛ=Σᵢ₌₀^{N}^{_{SRU,u}}⁻¹ N_{ss,i}, and N_{ss,i} is the number of spatial streams for RU_i.

In an example, the RU which is transmitted is associated with a single user u. In an example, the number of coded bits per orthogonal frequency division multiplexed (OFDM) symbol over an assigned RU for user u may be represented as N_{CPBS,u} which is the summation of number of coded bits per OFDM symbol over all the RU fragments N_{CBPS,u}=Σᵢ₌₀^{N}^{_{SRU,u}}⁻¹ N_{CBPS,i,u}, where N_{SRU,u} is the number of RU fragments (SRU) within the assigned RU, N_{CBPS,i,u}=N_{SD,u,i} Σ_{S=1}^{N}^{_{ss,u}} log₂ M_{u,i,s} is number of coded bits of the ith RU fragments per OFDM symbol. N_{SD,u,i} is the number of data tones of the ith RU fragment, M_{u,i,s} is the modulation order of spatial stream s within the ith RU fragment, N_{ss,u} is the number of spatial streams for user u. The number of coded bits per OFDM symbol segment can be calculated as N_{CBPS,short,u}=Σᵢ₌₀^{N}^{_{SRU,u}}⁻¹ N_{SD,short,i,u} Σₛ₌₁^{N}^{_{ss,u}} log₂ M_{u,i,s}, and N_{SD,short,i,u} is the number of data tones of the ith RU fragment within one OFDM symbol segment for user u. The RU parser for spatial stream s may divide N_{CBPSS,s,U}=Σᵢ₌₀^{N}^{_{SRU,u}}⁻¹ N_{CBPSS,i,s,u} coded bits into N_{SRU,u} blocks each with N_{CBPSS,i,s,u}=N_{SD,u,i}·log₂ M_{u,i,s} bits for spatial stream s within the ith RU fragments. The segment parser used in the ith RU fragment with size greater than 996-tone further divides N_{CBPSS,i,s,u} coded bits on spatial stream s into L blocks of N_{CBPSS,l,i,s,u} bits respectively, where l is the index of each 80 MHz frequency subblock index, and l=0,1 since the largest size of the RU fragment is 2×996-tone.

An AP or client station may signal unequal modulation in a user info field of a PPDU such as an EHT signal (SIG) field of a PPDU and a number of spatial streams Nss for transmitting an RU fragment or RU. The PPDU may have one or more user info fields. For downlink (DL) transmission from an AP to an client station, each user info field of the SIG field may have 22 bits and 2 bits are a “number of RU fragments” subfield to indicate 2-5 RU fragments of an RU (number of RU fragments=“number of RU fragments” subfield value+2). In one example, a first user info field MCS and Nss subfields may be the MCS and Nss values for the assigned RU. In another example, a first user info field MCS and Nss subfields may be a maximum MCS and maximum Nss values over all RU fragments of an RU. In a third example, a first user info field MCS and Nss subfields may be the MCS/Nss values for the first RU fragment. The PPDU may have a 1-bit subfield “unequal modulation_Nss” in a SIG user info field of a PPDU. Subfield “unequal modulation_Nss” is set to 0 to indicate only one SIG user info field for the client station. Subfield “unequal_modulation_Nss” is set to 1 to indicate there are one or more appended user info fields for this user corresponding to RU fragments of an RU.

An AP or client station may also signal unequal modulation in a user info field of a Basic Trigger frame such as in a Trigger Dependent User Info field. For uplink (UL) transmission, a 1-bit subfield “unequal_modulation_Nss” may be defined in each Basic Trigger frame user info field. Subfield “unequal_modulation_Nss” is set to 0 to indicate no more additional subfields in a Basic Trigger Frame User Info field. Subfield “unequal_modulation_Nss” is set to 1 to indicate there are additional user info subfields in the Basic Trigger Frame User Info field.

The RU fragments can be multiples of 26-tones RU (e.g., 26-tone, 52-tone or 106-tone) depending on the assigned RU size if the assigned RU size is less than or equal to 242-tones, otherwise the small resource units is multiples of 242-tones RU (equivalent to 20 MHz bandwidth). From common info field contents of a DL PPDU, each client station knows the assigned RU location in a bandwidth and RU size for DL transmission. The appended user info field includes a new subfield “number of RU fragments.” For UL transmission, each client station also knows the assigned RU location in a bandwidth and RU size from an RU allocation subfield in an client station user info field of a DL PPDU to the client station. The Basic Trigger frame user info field includes a new subfield “number of RU fragments.” Using the value set in “number of RU fragments”, the client station can determine each RU fragment size. In an example, up to five RU fragments with different modulations or Nss within the RU may be used to represent channel variations based on channel and interference statistics in a typical WiFi environment and to maintain a same transmission rate over the RU fragments. For example, if the assigned RU size is 996-tone (80 MHz channel), and “number of RU fragments” indicates 4 RU fragments, then RU fragment is 242-tone RU. If the assigned RU size is 242-tone, and the “number of RU fragments” indicates 5 RU fragments, then RU fragment are [52 52 26 52 52] tones. For client stations participating in MU-MIMO transmission with a single user on each RU and RUs being disjoint (i.e., not overlapping in frequency) for different users, Nss for transmitting the RU fragments needs to be the same over an assigned RU.

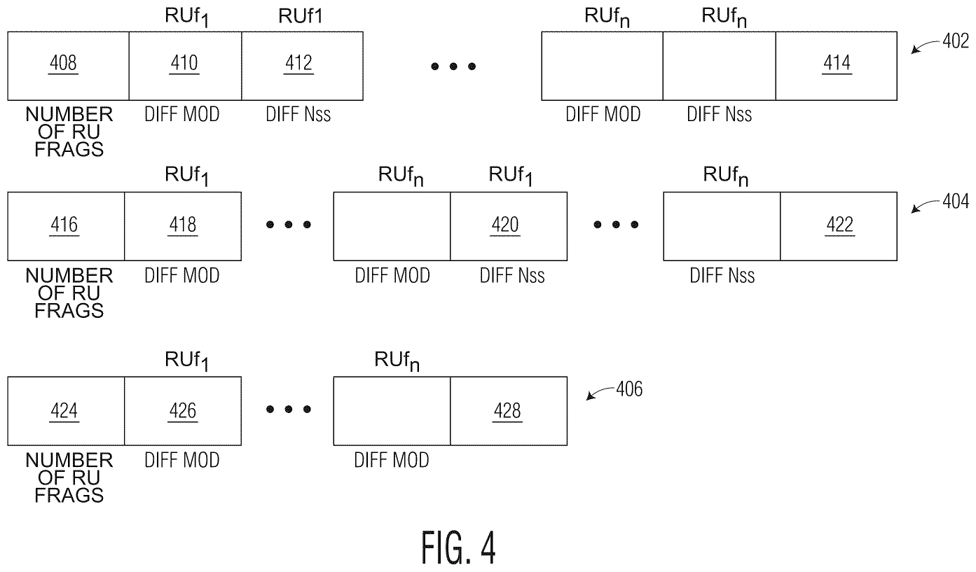

FIG. 4 illustrates example signaling in user information of a PPDU to transmit RU fragments in accordance with an embodiment. Appended user info field is shown which is appended to a frame having the first user info and may indicate one or more of a modulation of RU fragments of an RU referred to as RUf₁ to RUfₙ and a number of spatial streams to transmit the RU fragments. For DL transmission signaling, client station-ID, beamforming and coding subfields of the appended user info field may not be included in the signaling. Further, an MCS subfield in the signaling can be replaced with differential modulation subfield with less bit width and an differential Nss subfield with less bit width. The differential modulation indicates a differential modulation to transmit an RU fragment and the differential Nss subfield which indicates a differential number of spatial streams to transmit a RU fragment. In one example, the user field indicates a number of RU fragments and a differential modulation from an earlier user info field for the user and a differential Nss from an earlier user info field for the user. Up to 10-12 bits may be allocated for a differential modulation subfield and up to 8-10 bits for a differential Nss subfield may be allocated in the appended user info field depending on contents of the first user info field. In an example, 2 bits differential modulation [−2 −1 0 1] subfield and 2 bits differential Nss [−1 0 1 2] subfield may be used for each RU fragments if the MCS and Nss subfields of the first user info field are the MCS and Nss values for the assigned RU. In an example, 2 bits differential modulation [−3 −2 −1 0] subfield and 2 bits differential Nss [−3 −2 −1 0] subfield may be used for each RU fragment if MCS and Nss subfields of the first user info field are the maximum MCS and Nss values over all RU fragments of an RU. In an example, 3 bits differential modulation [−3 −2 −1 0 1 2 3 4] subfield and 2 bits differential Nss [−1 0 1 2] subfield for each RU fragments may be used if MCS and Nss subfields of the first user info field are the MCS and Nss values for the first RU fragment of an RU.

Signaling 402 shows example field 408 which indicate a number of RU fragments followed by a differential modulation field 410 and differential number of spatial streams field 412 in the signaling 402 for RUf₁ and corresponding information is provided for RUF₂ to RUFₙ and terminated by a reserved field 414. The differential modulation (Diff MOD) and differential number of spatial streams (Diff Nss) in the respective fields is a difference in modulation of a RU fragment and difference in number of spatial streams to transmit an RU fragment from a modulation and number of spatial streams defined for an RU fragment in an earlier user info field. For example, the differential modulation may be a difference in number of tones to transmit the RU fragment and a differential number of spatial streams may be a difference in number of spatial streams to transmit the RU fragment. Signaling 404 shows example field 416 which indicate a number of RU fragments followed by a differential modulation field 418 which indicates a differential modulation for RUF₁. The differential modulation field for each RUF₂ to RUFₙ may then be defined in the signaling 404 followed by differential number of spatial stream field 420 for RUF₁. The differential number of spatial stream field for each RUF₂ to RUFₙ may then be defined in the signaling 404 followed by a reserved field 414. In an example, the user info fields shown in signaling 402-404 may be used for wireless devices that are participating in SU-MIMO transmissions.

For implementation simplicity and to reduce signaling overhead, it is desirable to have the same Nss over all RU fragments for client stations participating in SU-MIMO. Based on the typical channel quality reports and use cases, lower Nss combined with a higher MCS is exchangeable with a higher Nss combined with a lower MCS to achieve comparable throughput at a given SNR. The differential Nss subfield can be removed for client stations not participating in any MU-MIMO transmissions and be the same for the assigned RU. For client stations participating in MU-MIMO transmission where RUs do not at least partially overlap in frequency at a same time, Nss may also need to be the same over the assigned RU.

Signaling 406 shows example field 424 which indicate a number of RU fragments followed by a differential modulation field 426 which indicates a differential modulation for RUF₁. The differential modulation field for each RUF₁ to RUFₙ may be defined in the signaling 406 followed by reserved field 428. In this example, the Nss may not change for each RU fragment from the first user info field and not included in the signaling 406. Further, the user info fields shown in FIG. 4C may be used for wireless devices that are participating in either full bandwidth or partial bandwidth MU-MIMO transmission which do not overlap in frequency or SU-MIMO transmission. In an example, up to 10-20 bits may be allocated for a differential modulation subfield and up to 8 bits allocated for a differential Nss subfield. In an example, a same Nss may be selected for all RU fragments. Furthermore, Nss is set to 2 based on typical use cases.

Different modulations may further be specified for each spatial stream that carry an RU fragment to improve throughput when channel condition numbers are high, e.g., non-line of sight channels. To reduce signaling overhead, a same Nss may be applied across all RU fragments. Nss may be set to two in typical use cases. In an example, a first user info field MCS subfield may be the MCS value for the assigned RU or the first user info field is the maximum MCS value over all smaller RU fragments. A subsequent user info field may use up to 20 bits for a differential modulation subfield. For example, 2 bit may be defined for a first spatial stream and 2 bits may be defined for second spatial stream for each RU fragment. The 2-bit differential modulation for the second spatial stream may indicate the modulation difference between the two streams for each RU fragment where a value 0 indicates same modulation, values 1, 2 and 3 indicates one, two or three modulation order differences. In another example, a first user info field MCS subfield may be the MCS value for first RU fragment and a subsequent user info fields may use up to 20 bits for differential modulation subfield. For example, 3 bit may be used for first spatial stream, 2 bit may be used for second spatial stream within each RU fragment. A 2-bit differential modulation for the second spatial stream may indicate the modulation difference between the two streams for each RU fragment: value 0 indicates same modulation and values 1, 2 and 3 indicates one, two or three modulation order differences.

In an example, the fields of signaling 402, 404, 406 may be repeated for each RU to be transmitted which is associated with a respective user. In this way, the PPDU may include a plurality of appended user information fields.

For UL transmission signaling, a “number of RU fragments” subfield, “differential modulation” subfield and “differential Nss subfield” may be appended at the end of a Trigger Dependent user info subfield in a Basic Trigger frame. The differential Nss subfield may not be provided when client stations participate in MU-MIMO transmission or SU-MIMO transmission. The appended subfields need up to 3 more bytes for client station participating in SU-MIMO transmission or up to 2 more bytes for client station participating in in either full bandwidth or partial bandwidth MU-MIMO transmission which do not overlap in frequency.

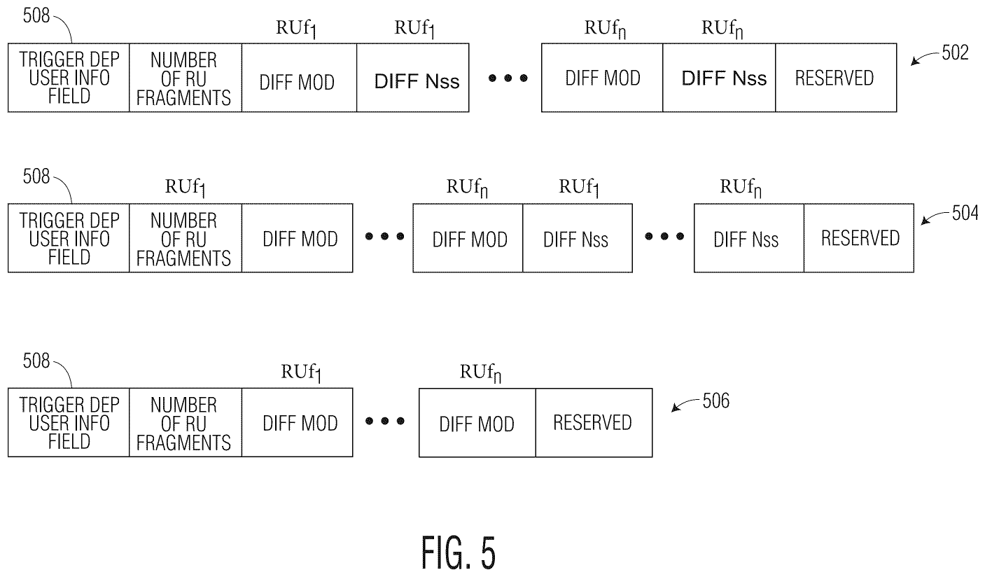

FIG. 5 illustrates example signaling 502-406 in user information of a basic trigger frame to transmit RU fragments in accordance with an embodiment. The basic trigger frame may include a first trigger dependent user info field 508 defining contents of the first user info field described above followed by appended additional user info fields for one or more RU fragments. Each of the appended user info field examples may include the “number of RU fragments” subfield, “differential modulation” subfield, and “differential Nss subfield” which are appended to the trigger dependent user info subfield 508 in the basic trigger frame. Signaling 502 illustrates indicating a number of RU fragments followed by a differential modulation field and differential number of spatial streams field for RUf₁, corresponding information for RUF₂ to RUFₙ, and terminated by a reserved field. Signaling 504 indicates a number of RU fragments followed by a differential modulation field which indicates a differential modulation for RUF₁. The differential modulation field for each RUF₂ to RUFₙ may be then defined followed by differential spatial stream field for RUF₁. The differential spatial stream field for each RUF₂ to RUFₙ may be then defined in the signaling followed by a reserved field. Signaling 506 indicates a number of RU fragments followed by a differential modulation field which indicates a differential modulation for RUF₁. The differential modulation field for each RUF₂ to RUFₙ may be then defined followed by reserved field.

In an example, unequal modulation may be allocated for MU-MIMO transmission when a bandwidth of an RU of one user partially overlaps with a bandwidth of an RU of another user during a simultaneous transmission to the two users.

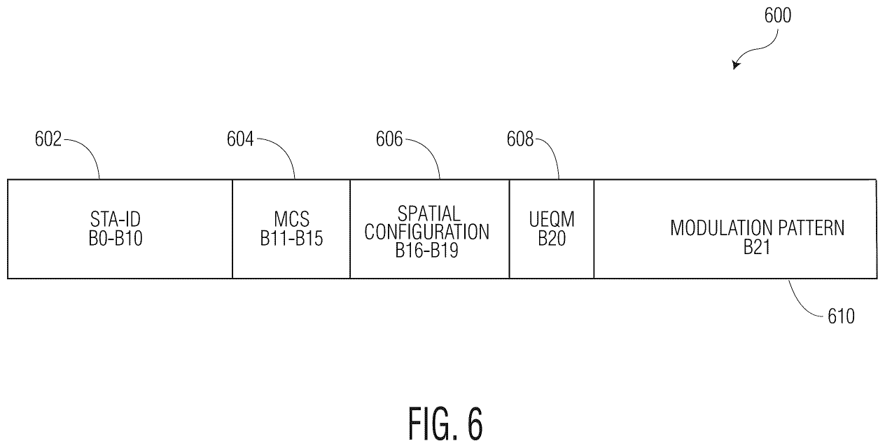

FIG. 6 is an example of signaling unequal modulation for partially overlapping bandwidth RU of different users for a MU-MIMO transmission in accordance with an embodiment. Signaling may include a user information field 600 of a PPDU or basic trigger frame which may be 22 bits and have a station identifier field 602, MCS field 604, a spatial configuration field 606, an unequal quadrature modulation (UEQM) field 608, and a modulation pattern field 610 to indicate the unequal modulation rather than appending an additional user info field for the RU fragments as shown in FIGS. 4-5. Bits allocated to the different fields may be indicated by Bi where “i” is an integer and corresponds to a bit. The MCS field 604 may indicate a modulation and coding for a first RU fragment such as modulation and coding for a primary 80 MHz channel. The spatial stream configuration field 606 may indicate a number of different spatial streams for transmitting RU fragments of the RU. In an example, the UEQM field 608 may indicate unequal modulation or equal modulation. The modulation pattern field 610 may indicate a differential modulation for a second RU fragment compared to the modulation indicated by the MCS field 604 of a first RU. In an example, one of the RU fragments overlaps with a smaller bandwidth of a second user and the overlapping RU fragment has a different modulation. If the unequal modulation is indicated, then the modulation pattern field 610 may indicate one QAM or two QAM difference on the second RU fragment of the RU as a modulation pattern such as in a secondary 80 MHz channel compared to the first RU fragment. If more than two modulation patterns are needed for the RU with two RU fragments, a bit of the client station-ID field 602 may be reused or another bit added to user info field 600 to indicate more than two patterns. In some examples, the bits of the UEQM field 608 and bits of the modulation pattern field 610 may be combined to indicate the modulation pattern.

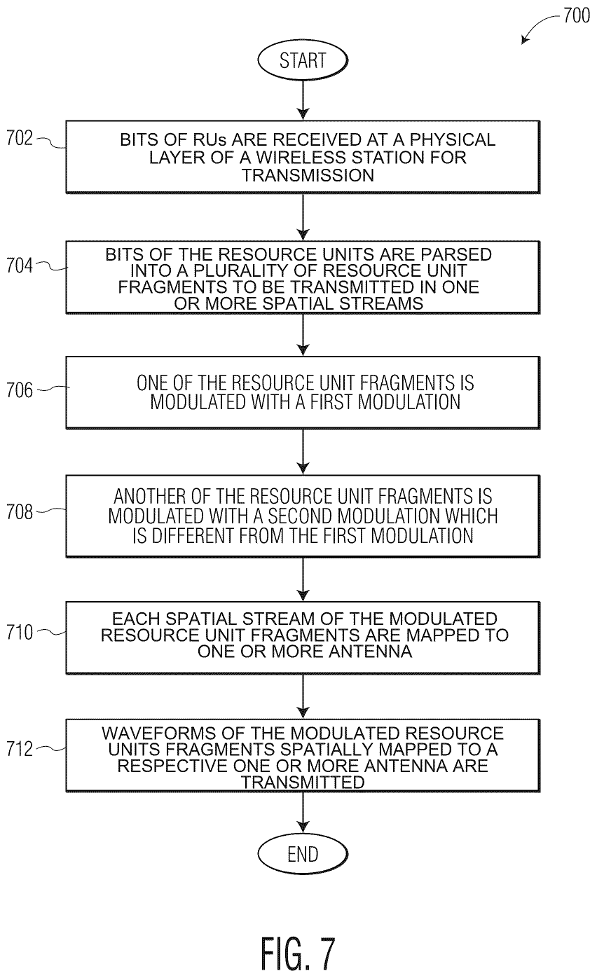

FIG. 7 is a flow chart of functions 700 for transmitting RU fragments in accordance with an embodiment. At 702, bits of RUs are received at a physical layer of a wireless station for transmission. The wireless station may be an AP or client station in an example. At 704, bits of the resource units is parsed into a plurality of resource unit fragments to be transmitted in one or more spatial streams. Different resource unit fragments may have unequal modulation and parsed to different spatial streams. Alternatively, different resource unit fragments may have unequal modulation and parsed to a varying number of spatial streams. The resource unit fragments may have a plurality of tones and be a multiple of 242 tones or a multiple of 26 tones if the resource unit fragment is less than 242 tones. At 706, one of the resource unit fragments is modulated with a first modulation. The modulation may be QPSK or QAM in an example. At 708, another of the resource unit fragments is modulated with a second modulation which is different from the first modulation. At 710, each spatial stream of the modulated resource unit fragments are spatially mapped to one or more antenna. At 712, waveforms of the modulated resource units fragments spatially mapped to a respective one or more antenna are transmitted. System performance such as throughput and latency is improved associated with transmission of the RU fragments of RUs with different modulation by a transmitter and an signal-to-noise ratio of RU fragments received by a wireless device is similar across channels without complexity associated with using different data rates for RU fragments.

In an embodiment, a method for wireless transmission is disclosed. The method comprises: receiving bits of resource units (RU) at a physical layer processing unit of a wireless device; parsing the bits of the RUs into a plurality of RU fragments carried by one or more spatial streams; modulating one of the resource unit fragments with a first modulation; modulating another of the resource unit fragments with a second modulation which is different from the first modulation; and mapping each spatial stream carrying the resource units fragments which are modulated to one or more antenna for wireless transmission. In an example, parsing the bits of the RUs comprises parsing bits of the RUs into a plurality of spatial streams of RUs and parsing a spatial stream of an RU into one or more RU fragments. In an example, different spatial streams are parsed into different resource unit fragments which have unequal modulation. In an example, parsing the bits of the RUs comprises parsing bits of the RUs into a plurality of RU fragments and parsing bits of an RU fragment into one or more spatial streams. In an example, different resource unit fragments are parsed into different numbers of spatial streams. In an example, the method further comprises parsing an RU fragment of the plurality of RU fragments into a plurality of RU segments if the RU fragment size is larger than 80 MHz. In an example, the method further comprises jointly encoding bits of the RU. In an example, the method further comprises parsing an RU fragment of the plurality of RU fragments into a plurality of RU segments, wherein a minimum RU segment size is 20 MHz or 80 MHz and a maximum number of RU segments is four. In an example, the one RU fragment and the other RU fragment of an RU are to be transmitted to a first device, the other RU fragment overlaps with a bandwidth of a second device and the one RU fragment does not overlap with the bandwidth of the second device, the bandwidth of the second device being smaller than a bandwidth of the first device, the wireless transmission being a multi-user multiple input multiple output (MU-MIMO) transmission. In an example, the different modulation is based on interference detection or feedback from a receiver. In an example, the method further comprises signaling an unequal modulation for the resource unit fragments. In an example, the signaling is in one of a physical layer protocol data unit (PPDU) and a Basic Trigger frame. In an example, the signaling includes transmitting a frame which comprises for each resource unit fragment a field indicating a number of resource unit fragments in the resource unit, a field indicating a differential modulation for one of the resource unit fragment with respect to modulation of the other resource unit fragment, and a differential number of spatial streams for transmitting the one resource unit fragment with respect to a number of spatial streams of the other resource unit fragment. In an example, the signaling includes transmitting a frame which comprises for each resource unit fragment a field indicating a number of resource unit fragments in the resource unit and a field indicating a differential modulation for one resource unit fragment with respect to modulation of the other resource unit fragment, the signaling not indicating a number of spatial streams to transmit the resource unit fragments. In an example, a user info field of the frame indicates one of a modulation and number of spatial streams for an RU, a maximum modulation and number of spatial streams for the resource unit fragments, and a modulation and number of spatial streams for the one resource unit fragment. In an example, the signaling includes transmitting a frame which comprises for each resource unit fragment a field indicating a modulation and coding scheme (MCS) of the one of the resource unit fragment, a field indicating a number of spatial streams for transmitting the one of the resource unit fragment, an unequal modulation field indication, and a differential modulation pattern for the other resource unit fragment based on a modulation indicated by the MCS. In an example, the signaling is performed in a MU-MIMO transmission where a bandwidth of the RU for one user partially overlaps with a bandwidth of another RU for another user, the bandwidths being different sizes. In an example, the one RU fragment is further parsed into RU segments which each have different modulation.

In another embodiment a wireless device is disclosed. The wireless device is arranged to receive bits of resource units (RU) at a physical layer processing unit of a wireless device; parse the bits of the RUs into a plurality of RU fragments carried by one or more spatial streams; modulate one of the resource unit fragments with a first modulation; modulate another of the resource unit fragments with a second modulation which is different from the first modulation; and map each spatial stream carrying the resource units fragments which are modulated to one or more antenna for transmission. In an example, the wireless device arranged to parse bits of the RUs into a plurality of spatial streams of RUs and parse a spatial stream of an RU into one or more RU fragments. In an example, the wireless device arranged to parse the bits of the RUs comprises the wireless device arranged to parse bits of the RUs into a plurality of RU fragments and parse bits of an RU fragment into one or more spatial streams. In an example, the wireless device is further arranged to transmit a frame which comprises for each resource unit fragment a field indicating a modulation and coding scheme (MCS) of the one of the resource unit fragment, a field indicating a number of spatial streams for transmitting the one of the resource unit fragment, an unequal modulation field indication, and a differential modulation pattern for the other resource unit fragment based on a modulation indicated by the MCS. In an example, the one RU fragment is further parsed into RU segments which each have different modulation.

The foregoing disclosure provides illustration and description but is not intended to be exhaustive or to limit the aspects to the precise form disclosed. Modifications and variations may be made in light of the above disclosure or may be acquired from practice of the aspects.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of. a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless transmission comprising:
receiving bits of resource units (RU) at a physical layer processing unit of a wireless device;
parsing the bits of the RUs into a plurality of RU fragments carried by one or more spatial streams;
modulating one of the resource unit fragments with a first modulation;
modulating another of the resource unit fragments with a second modulation which is different from the first modulation; and
mapping each spatial stream carrying the resource units fragments which are modulated to one or more antenna for wireless transmission.

2. The method of claim 1, wherein parsing the bits of the RUs comprises parsing bits of the RUs into a plurality of spatial streams of RUs and parsing a spatial stream of an RU into one or more RU fragments.

3. The method of claim 2, wherein different spatial streams are parsed into different resource unit fragments which have unequal modulation.

4. The method of claim 1, wherein parsing the bits of the RUs comprises parsing bits of the RUs into a plurality of RU fragments and parsing bits of an RU fragment into one or more spatial streams.

5. The method of claim 4, wherein different resource unit fragments are parsed into different numbers of spatial streams.

6. The method of claim 1, further comprising parsing an RU fragment of the plurality of RU fragments into a plurality of RU segments if the RU fragment size is larger than 80 MHz.

7. The method of claim 1, further comprising jointly encoding bits of the RU.

8. The method of claim 1, further comprising parsing an RU fragment of the plurality of RU fragments into a plurality of RU segments, wherein a minimum RU segment size is 20 MHz or 80 MHz and a maximum number of RU segments is four.

9. The method of claim 1, wherein the one RU fragment and the other RU fragment of an RU are to be transmitted to a first device, the other RU fragment overlaps with a bandwidth of a second device and the one RU fragment does not overlap with the bandwidth of the second device, the bandwidth of the second device being smaller than a bandwidth of the first device, the wireless transmission being a multi-user multiple input multiple output (MU-MIMO) transmission.

10. The method of claim 1, wherein the different modulation is based on interference detection or feedback from a receiver.

11. The method of claim 1, further comprising signaling an unequal modulation for the resource unit fragments.

12. The method of claim 11, wherein the signaling is in one of a physical layer protocol data unit (PPDU) and a Basic Trigger frame.

13. The method of claim 11, wherein the signaling includes transmitting a frame which comprises for each resource unit fragment a field indicating a number of resource unit fragments in the resource unit, a field indicating a differential modulation for one of the resource unit fragment with respect to modulation of the other resource unit fragment, and a differential number of spatial streams for transmitting the one resource unit fragment with respect to a number of spatial streams of the other resource unit fragment.

14. The method of claim 11, wherein the signaling includes transmitting a frame which comprises for each resource unit fragment a field indicating a number of resource unit fragments in the resource unit and a field indicating a differential modulation for one resource unit fragment with respect to modulation of the other resource unit fragment, the signaling not indicating a number of spatial streams to transmit the resource unit fragments.

15. The method of claim 14, wherein a user info field of the frame indicates one of a modulation and number of spatial streams for an RU, a maximum modulation and number of spatial streams for the resource unit fragments, and a modulation and number of spatial streams for the one resource unit fragment.

16. The method of claim 11, wherein the signaling includes transmitting a frame which comprises for each resource unit fragment a field indicating a modulation and coding scheme (MCS) of the one of the resource unit fragment, a field indicating a number of spatial streams for transmitting the one of the resource unit fragment, an unequal modulation field indication, and a differential modulation pattern for the other resource unit fragment based on a modulation indicated by the MCS.

17. The method of claim 16, wherein the signaling is performed in a MU-MIMO transmission where a bandwidth of the RU for one user partially overlaps with a bandwidth of another RU for another user, the bandwidths being different sizes.

18. The method of claim 1, wherein the one RU fragment is further parsed into RU segments which each have a different modulation.

19. A wireless device arranged to receive bits of resource units (RU) at a physical layer processing unit of a wireless device; parse the bits of the RUs into a plurality of RU fragments carried by one or more spatial streams; modulate one of the resource unit fragments with a first modulation; modulate another of the resource unit fragments with a second modulation which is different from the first modulation; and map each spatial stream carrying the resource units fragments which are modulated to one or more antenna for transmission.

20. The wireless device of claim 19, wherein the wireless device arranged to parse bits of the RUs into a plurality of spatial streams of RUs and parse a spatial stream of an RU into one or more RU fragments.

21. The wireless device of claim 19, wherein the wireless device arranged to parse the bits of the RUs comprises the wireless device arranged to parse bits of the RUs into a plurality of RU fragments and parse bits of an RU fragment into one or more spatial streams.

22. The wireless device of claim 19, further arranged to transmit a frame which comprises for each resource unit fragment a field indicating a modulation and coding scheme (MCS) of the one of the resource unit fragment, a field indicating a number of spatial streams for transmitting the one of the resource unit fragment, an unequal modulation field indication, and a differential modulation pattern for the other resource unit fragment based on a modulation indicated by the MCS.

23. The wireless device of claim 19, wherein the one RU fragment is further parsed into RU segments which each have a different modulation.
